(19) United States
(12) Patent Application Publication
(10) Pub. No.: US 2009/0133056 A1
(43) Pub. Date: May 21, 2009

(54) BROADCASTING SYSTEM AND METHOD OF PROCESSING EMERGENCY ALERT MESSAGE

(75) Inventor: Chang Sik YUN, Daejeon (KR)

Correspondence Address: MCKENNA LONG & ALDRIDGE LLP, 1900 K STREET, NW, WASHINGTON, DC, 20006, US

(73) Assignee: LG ELECTRONICS INC., Seoul (KR)

(21) Appl. No.: 12/285,801

(22) Filed: Oct. 14, 2008

(30) Foreign Application Priority Data
Oct. 17, 2007 (KR) 10-2007-0104472

(51) Int. Cl. H04N 7/025

(52) U.S. Cl. 725/33

(57) ABSTRACT

In a broadcasting system for transmitting/receiving an emergency alert message, a receiving system includes a host and a card which is detachably connected to the host. The host receives and processes the emergency alert message transmitted from a transmitting system and collects and transmits status information of the emergency alert message, which is currently being processed or was already processed, to a card. The card requests the status information of the emergency alert message to the host and receives and transmits the status information of the emergency alert message transmitted from the host to the transmitting system.

This application claims the benefit of Korean Patent Application No. 10-2007-0104472, filed on Oct. 17, 2007, which is hereby incorporated by reference as if fully set forth herein.

### BACKGROUND OF THE INVENTION

1. Field of the Invention

The present invention relates to a broadcasting system capable of transmitting/receiving an emergency alert message, and more particularly, to a method of processing an emergency alert message.

2. Discussion of the Related Art

Among digital broadcasting systems, a cable broadcasting system may include a cable broadcasting station which is a transmitter for transmitting a cable broadcasting signal and a broadcasting receiver which is a receiver for receiving the transmitted cable broadcast signal. The cable broadcasting station may be called a headend.

The broadcasting receiver uses an open cable scheme for separating a cablecard from a main body. In this case, for example, a PCMCIA card is used as the cablecard and can be detachably connected to a slot of the main body of the cable broadcasting receiver. The cablecard is also called a point of deployment (POD) module or a card. The main body in which the cablecard is inserted is called a host. For example, a digital built-in television or a digital ready television corresponds to the host. Hereinafter, the host and the cablecard are collectively called a cable broadcasting receiver.

In such a cable broadcasting system, a basic protocol that, when the transmitter transmits an emergency alert message against an emergency, the broadcasting receiver receives and processes the emergency alert message is defined.

If the emergency alert message is transmitted via a specific frequency of a terrestrial wave or cable, the host in the broadcasting receiver receives the emergency alert message. The host outputs information on the switch to an emergency channel and an emergency alert in order to efficiently provide information on the emergency alert to a user currently watching the TV.

However, if the power of the broadcasting receiver is turned off, the broadcasting receiver cannot receive and process the emergency alert message although the emergency alert message is transmitted. Thus, the user of the broadcasting receiver, for example, a cable broadcasting subscriber cannot receive the emergency alert message and thus cannot properly cope with the emergency.

### SUMMARY OF THE INVENTION

Accordingly, the present invention is directed to a broadcasting system and a method of processing an emergency alert message that substantially obviate one or more problems due to limitations and disadvantages of the related art.

An object of the present invention is to provide a broadcasting system, which enables a transmitting system for transmitting an emergency alert message to manage an emergency alert message processing status, and a method of processing an emergency alert message.

Another object of the present invention is to provide a broadcasting system for transmitting status information of an emergency alert message, which is being processed or was processed by a broadcasting receiver, to a transmitting system using a diagnostic function, and a method of processing the emergency alert message.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a receiving system includes a host and a card. The host receives and processes an emergency alert message transmitted from a transmitting system and collects and transmits status information of the emergency alert message, which is currently being processed or was already processed, to the card. The card requests the status information of the emergency alert message to the host, and receives and transmits the status information of the emergency alert message transmitted from the host to the transmitting system.

In another aspect of the present invention, a method of processing an emergency alert message of a receiving system includes receiving and processing the emergency alert message transmitted from a transmitting system; and, when a request for transmission of status information of the emergency alert message is received from the transmitting system, collecting and transmitting the status information of the emergency alert message, which is currently being processed or was already processed, to the transmitting system according to the request.

In another aspect of the present invention, a method of processing an emergency alert message of a transmitting system includes generating and transmitting the emergency alert message including at least one of an identifier, a time information and an indicating information to a receiving system; requesting status information of the emergency alert message to the receiving system; and analyzing the status information of the emergency alert message transmitted from the receiving system and performs management of the emergency alert message of the receiving system according to the analyzed result.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a conceptual diagram showing a cable broadcasting network including a host and a cablecard, according to an embodiment of the present invention;

FIG. 2 is a conceptual diagram showing an embodiment of a process of requesting and confirming diagnostic information between the cablecard and the host according to the present invention;

FIGS. 3A and 3B are views showing an embodiment of assigning a diagnostic ID for the diagnosis of an EAS status according to the present invention;

FIGS. 4A and 4B are views showing an embodiment of a syntax structure of collecting and transmitting diagnostic information when a diagnostic request is received in an S-mode;

FIGS. 5A and 5B are views showing an embodiment of a syntax structure of collecting and transmitting diagnostic information when a diagnostic request is received in an M-mode;

FIG. 6 is a view showing an embodiment of the diagnostic syntax structure for EAS status information according to the present invention;

FIG. 7 is a flowchart illustrating a process of requesting and confirming EAS status information between the host and the cablecard in a broadcasting receiver using a diagnostic function according to an embodiment of the present invention;

FIG. 8 is a flowchart illustrating an operation of a headend according to the EAS status information transmitted from the cablecard according to the present invention; and

FIG. 9 is a block diagram showing a receiving system capable of receiving a cable broadcasting signal according to an embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

The configuration and operation of the present invention shown in the drawings and described hereinafter will be described in at least one embodiment, without limiting the spirit and scope of the present invention.

In addition, although the terms used in the present invention are selected from generally known and used terms, some of the terms mentioned in the description of the present invention have been selected by the applicant at his or her discretion, the detailed meanings of which are described in relevant parts of the description herein. Furthermore, it is required that the present invention is understood, not simply by the actual terms used but by the meanings of each term lying within.

In the present invention, an emergency alert message processing status of a broadcasting receiver is transmitted to a transmitting system for transmitting an emergency alert message such that the transmitting system provides the emergency alert to a user via another medium according to the emergency alert message processing status of the broadcasting receiver. For example, the emergency alert contents may be transmitted to a wire telephone or a mobile telephone of a cable broadcasting subscriber having a cable broadcasting receiver, that is, a user, via a voice or text message or telephone conversation.

In the embodiment of the present invention, it is assumed that the transmitting system for transmitting the emergency alert message is a headend. The transmitting system may be a cable broadcasting station or a content provider.

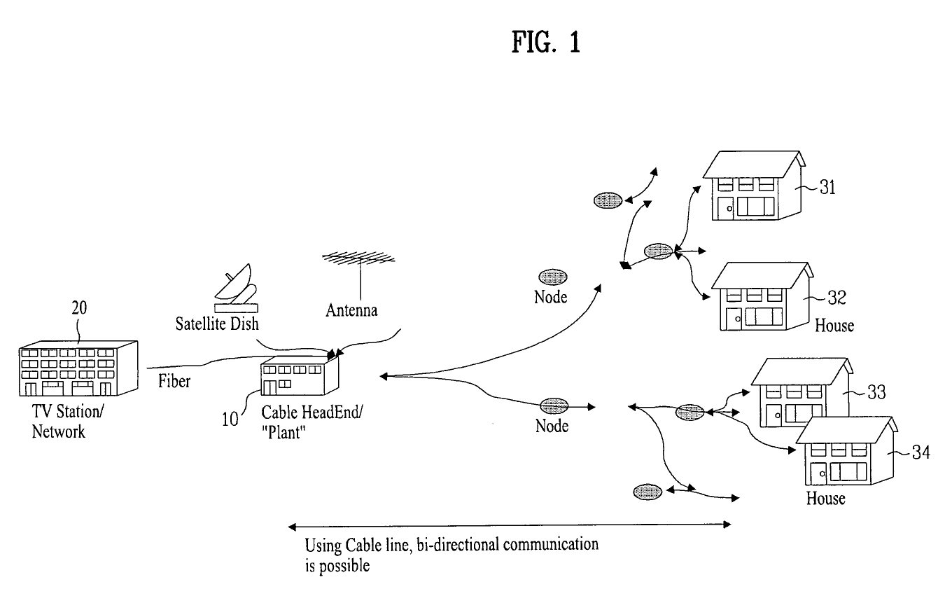

FIG. 1 is a conceptual diagram showing a cable broadcasting network including a broadcasting receiver and a headend according to an embodiment of the present invention. The headend/plant 10 may receive a broadcasting signal from a television broadcasting station 20 via various communication networks and transmit the broadcasting signal to broadcasting receivers 31 to 34 via cable networks including nodes. The broadcasting receivers and the headend/plate may transmit and receive data via a cable network infrastructure for bi-directionally transmitting data.

Each of the broadcasting receivers 31 to 34 includes a host and a cablecard. In the embodiment of the present invention, it is assumed that the cablecard is detachably connected to the host.

In the present invention, a broadcasting station transmits an emergency alert message via the headend, and the broadcasting receiver receives the emergency alert message if the power thereof is in an on state and switches a channel according to the contents included in the emergency alert message or outputs the information on the emergency alert in a text and/or a voice form.

The broadcasting receiver transmits an emergency alert message processing status to the headend according to the request of the headend or periodically. The headend analyzes the emergency alert message processing status of the broadcasting receiver and performs an operation according to the analyzed result. For example, if it is determined that the broadcasting receiver does not normally receive and process the emergency alert message, the headend may provide the emergency alert to the user via another medium instead of the broadcasting receiver, according to the importance degree of the transmitted emergency alert message.

In the embodiment of the present invention, the broadcasting receiver transmits the emergency alert message processing status to the headend using a diagnostic function.

In particular, the cablecard of the broadcasting receiver requests the emergency alert message processing status to the host using the diagnostic function according to the request of the headend or periodically, and the host checks and transmits the emergency alert message processing status to the cablecard according to the request. Then, the cablecard transmits the emergency alert message processing status transmitted from the host to the headend.

That is, the cable broadcasting specification includes a diagnostic function for monitoring the statuses of the host. This function indicates a function for checking the operation status of the host and the connection statuses of peripherals.

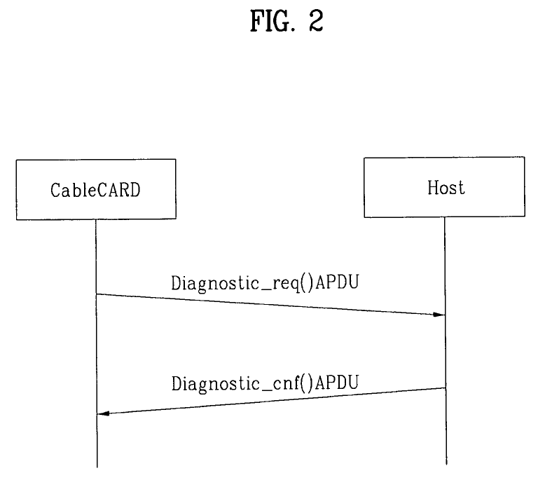

FIG. 2 is a conceptual diagram showing the diagnosis of the status of the host when the cablecard receives a diagnostic command for the status of the host, in which the cablecard is mounted, from the headend or the user, according to the present invention.

When the cablecard receives the diagnostic command for the status of the host connected to the cablecard from the headend or the user, the diagnostic command is sent to the host according to a predetermined protocol. The host which receives the diagnostic command from the cablecard collects the diagnostic information corresponding to the diagnostic command and transmits the collected diagnostic information to the cablecard according to the predetermined protocol.

At this time, the predetermined protocol may be, for example, a generic diagnostic protocol in case of an open cable. The generic diagnostic protocol is defined for monitoring a variety of system information of the host and a variety of status information of devices connected to the host by a local entity (user) or a remote entity in real time. According to this protocol, the cablecard transmits the diagnostic command to the host by a diagnostic request protocol, and the host transmits a confirmation for the transmitted diagnostic command to the cablecard by a diagnostic confirmation protocol.

At this time, the diagnostic request is transmitted in a state of being included in Diagnostic_req( )APDU (Application Protocol Data Unit) and the diagnostic confirmation is transmitted in a state of being included in Diagnostic_cnf( )APDU. The APDU is the unit of data which is exchanged between equal application entities in an application layer. For example, the diagnostic information is requested by the exchange of Diagnostic_req( )APDU and Diagnostic_cnf( )APDU on a data channel which is one of CPU interfaces between the cablecard and the host, and the diagnostic information collected according to the request is transmitted and received. At this time, when the cablecard makes a request for the diagnosis, the host should know what the requested diagnostic kind is in order to collect the diagnostic information corresponding thereto and report the diagnostic information to the cablecard.

In a cable broadcasting specification, the diagnostic kinds requested to the host are defined and identifiers (ID) are assigned to the diagnoses.

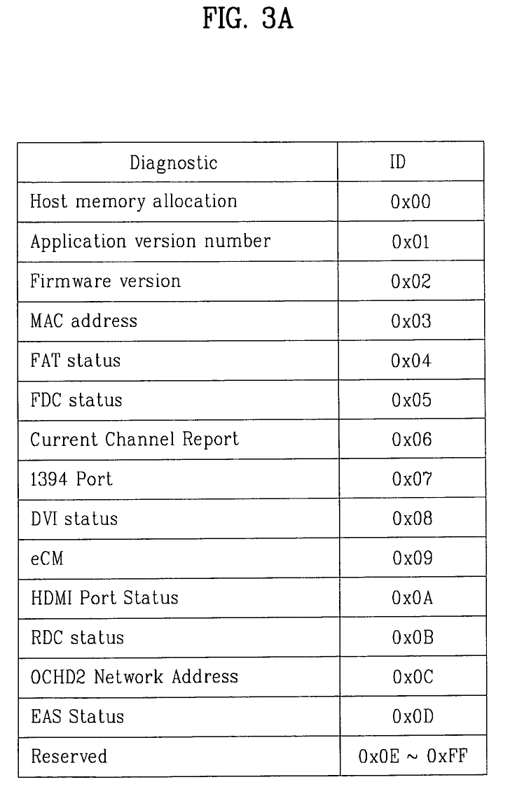

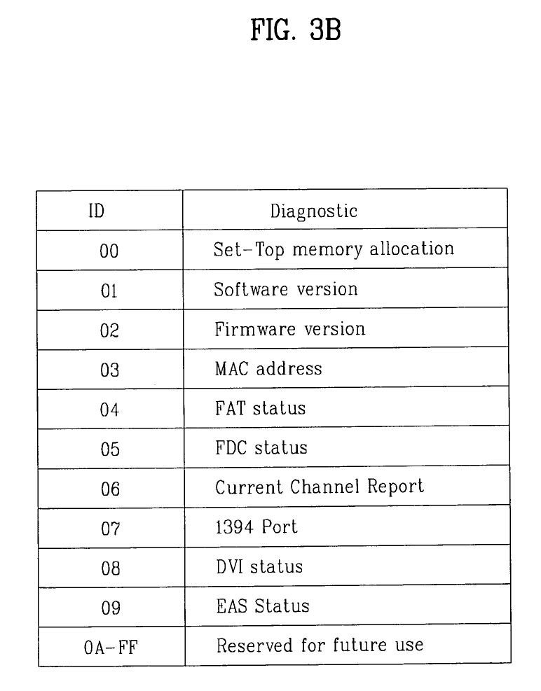

In one embodiment of the present invention, in a format in which the diagnostic kinds and the IDs are assigned as shown in FIG. 3A, 0x0D is assigned as a diagnostic ID of an emergency alert message processing status. That is, if the cablecard transmits the diagnostic request to the host and the diagnostic ID is 0X0D, the host collects the emergency alert message processing status information and reports it to the cablecard. In the present invention, the emergency alert message processing status is also called an emergency alert system (EAS) status. That is, in the present invention, the emergency alert message processing status is used as the same meaning as the EAS status.

At this time, the assignment of 0x0D as the diagnostic ID of the EAS status is only exemplary and any one of 0x0D to 0xFF may be assigned as the diagnostic ID of the EAS status. Alternatively, one of the diagnostic IDs which are already being used may be assigned as the diagnostic ID of the EAS status.

Alternatively, in one embodiment of the present invention, in a format in which the diagnostic kinds and the IDs are assigned as shown in FIG. 3B, 0x09 is assigned as the diagnostic ID of the EAS status. Similarly, this is only exemplary and any one of 0x09 to 0xFF may be assigned as the diagnostic ID of the EAS status. Alternatively, a diagnostic ID which is already being used may be assigned as the diagnostic ID of the EAS status.

Meanwhile, an interface between the cablecard and the host includes a single stream cablecard interface and a multi stream cablecard interface.

The single stream cablecard interface enables the cablecard to process a single broadcasting stream and the host to decode the single broadcasting stream, and the multi stream cablecard interface enables the cablecard to process multiple broadcasting streams and the host to decode the multiple broadcasting streams.

Hereinafter, the technique of the present invention will be described in a case where the cablecard processes the single stream (hereinafter, referred to as an “S-mode”) and a case where the cablecard processes the multiple streams (hereinafter, referred to as an “M-mode”).

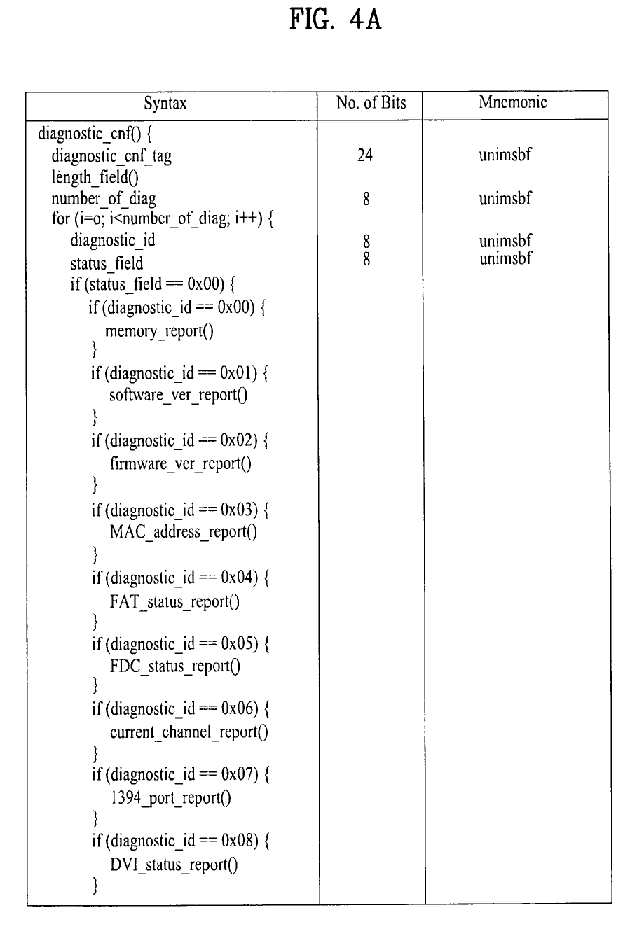

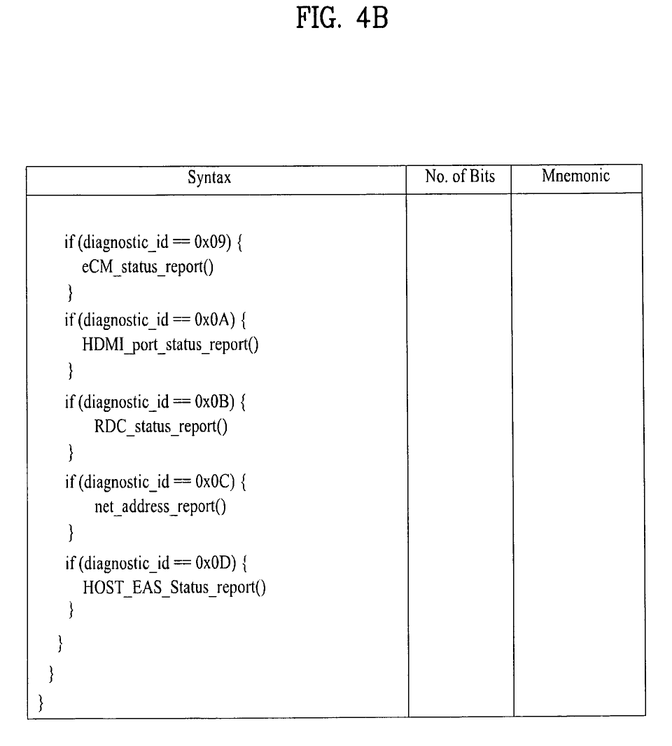

FIGS. 4A and 4B are views showing an embodiment of the syntax structure of an S-mode diagnostic confirmation protocol for transmitting the diagnostic result Diagnostic_cnf ( )APDU from the host to the cablecard when the cablecard transmits the diagnostic request Diagnostic_req( )APDU to the host according to the format in which the diagnostic kinds and the IDs are assigned as shown in FIG. 3A.

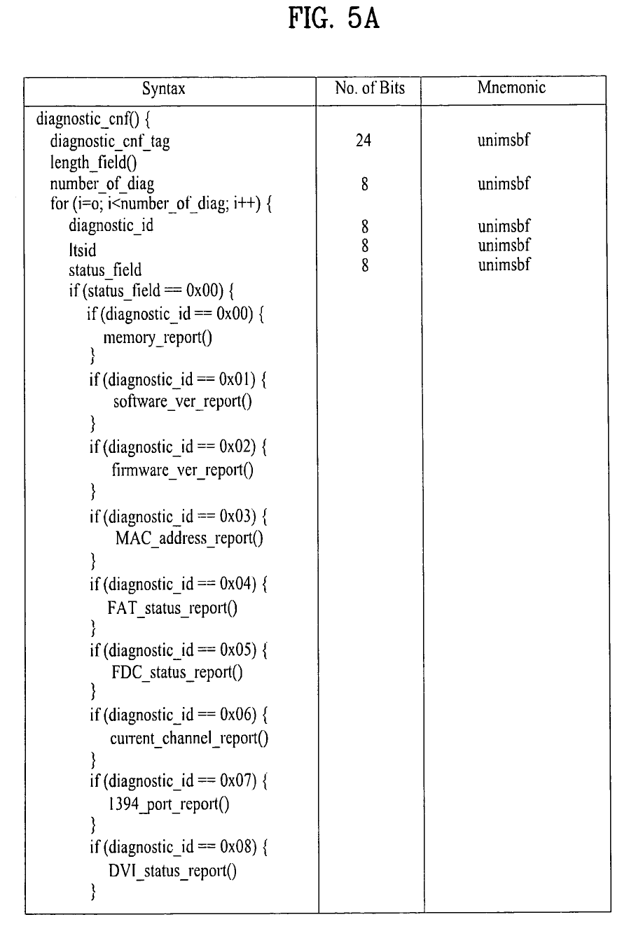

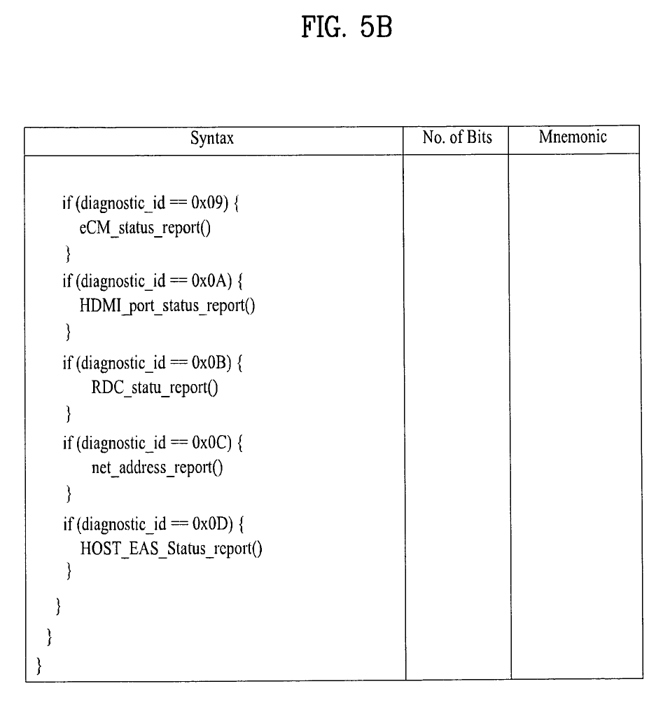

FIGS. 5A and 5B are views showing an embodiment of the syntax structure of an M-mode diagnostic confirmation protocol for transmitting the diagnostic result Diagnostic_cnf( )APDU from the host to the cablecard when the cablecard transmits the diagnostic request Diagnostic_req( )APDU to the host according to the format in which the diagnostic kinds and the IDs are assigned as shown in FIG. 3A.

The syntax of FIG. 5 is different from that of FIG. 4 in that the IDs (Itsid) of streams are declared with respect to a plurality of demultiplexed streams.

As shown in FIGS. 4 and 5, the host collects the EAS status information if a status field (status_field) value of the Diagnostic_req( )APDU transmitted from the cablecard is 0x00 ad the diagnostic ID (Diagnostic_id) is 0x0D, includes the collected EAS status information HOST_EAS_status_report( ) in the Diagnostic_cnf( )APDU, and transmits the Diagnostic_cnf( )APDU to the cablecard.

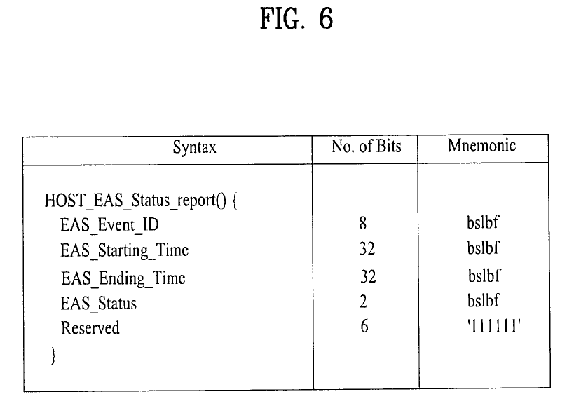

FIG. 6 is a view showing an embodiment of the syntax structure of the HOST_EAS_status_report( ) according to the present invention, which is an example of the EAS status information HOST_EAS_status_report( ) collected by the host according to the EAS status diagnostic request of the cablecard. The EAS status information HOST_EAS_status_report( ) collected by the host is transmitted to the cablecard in a state of being included in the Diagnostic_cnf( )APDU. Then, the cablecard transmits EAS status information HOST_EAS_status_report( ) transmitted from the host to the headend. The headend analyzes the EAS status information transmitted from the cablecard and manages an emergency alert message processing status of the broadcasting receiver according to the analyzed result. For example, the headend finishes the management of the emergency alert message of the broadcasting receiver, sends the emergency alert message to the broadcasting receiver again or informs the subscriber of the broadcasting receiver of the emergency alert status using another medium.

The syntax of the HOST_EAS_status_report( ) of FIG. 6 may include an EAS_Event_ID field, an EAS_Starting_Time field, an EAS_Ending_Time field and an EAS_Status field.

The EAS_Event_ID field is, for example, an 8-bit field that designates a particular emergency alert (EA) event. Each time a new EAS message is distributed throughout the cable system, a new EAS_Event_ID shall be assigned.

The EAS_Starting_Time field is, for example, a 32-bit field that designates the starting time of the emergency alert message corresponding to the EA event ID value included in the EAS_Event_ID field. For example, the starting time may be represented by a GPS time. The EAS_Starting_Time field value may represent a starting time extracted as the starting time information included in the received emergency alert message, a time when the host actually starts an operation corresponding to the emergency alert message (e.g., the switch of the channel or the display of the emergency alert contents of a text form), or a time when the emergency alert message is received by the host. In the present invention, it is assumed that the EAS_Starting_Time field represents the time when the host actually starts the operation corresponding to the emergency alert message (e.g., the switch of the channel or the display of the emergency alert contents of the text form).

The EAS_Ending_time field is, for example, a 32-bit field that designates the ending time of the EAS message corresponding to the EA event ID value included in the EAS_Event_ID field. At this time, the ending time may be represented by a GPS time. For example, a time when the channel is returned to an original channel after being switched to an emergency alert broadcasting channel according to the contents of the emergency alert message received by the host or a time when the emergency alert message which is being scrolled is finished may be represented as the ending time. If the EAS status information is requested when the emergency alert message is executed, the current time is represented as the ending time and is transmitted. If the power of the broadcasting receiver is turned off when the emergency alert message is processed, the off time may be represented as the ending time.

The EAS_Status field is, for example, a 2-bit field that designates processing status of the emergency alert message corresponding to the EA event ID value included in the EAS_Event_ID field.

For example, it is indicated that the emergency alert message is not received after the power of the broadcasting receiver is turned on if the EAS_Status field value is 00, it is indicated that the emergency alert message corresponding to the EA event ID is being received and processed if the EAS_Status field value is 01, and it is indicated that the processing of the emergency alert message corresponding to the EA event ID is finished if the EAS_Status field value is 10. The values assigned to the EAS_Status field and the definition thereof are only exemplary and the present invention is not limited to the above embodiment.

If the execution of the contents included in the received emergency alert message is started, the host stores the starting time and the EA event ID of the emergency alert message together. If the execution of the contents included in the emergency alert message is finished, the ending time and the EAS_Status field value are stored so as to be linked with the starting time and the EA event ID. At this time, in one embodiment of the present invention, it is assumed that the EAS_Status field value is 10. If the power of the broadcasting receiver is turned off when the emergency alert message is being processed, the off time is stored as the ending time and “10” is stored as the EAS_Status field value.

In one embodiment of the present invention, if a plurality of emergency alert messages is received after the power of the broadcasting receiver is turned on, the processing status of the emergency alert message corresponding to the EA event ID which is recently received is transmitted to the cablecard. Each time one emergency alert message is processed, the existing information on the processing of the emergency alert message may be updated to new information on the processing of the emergency alert message.

If the emergency alert message is not received after the power of the broadcasting receiver is turned on, the EAS_Status field value is represented by 00 and it is informed that the emergency alert message is not received after the power of the broadcasting receiver is turned on. If the power of the broadcasting receiver is turned off, the stored EAS status information may be deleted.

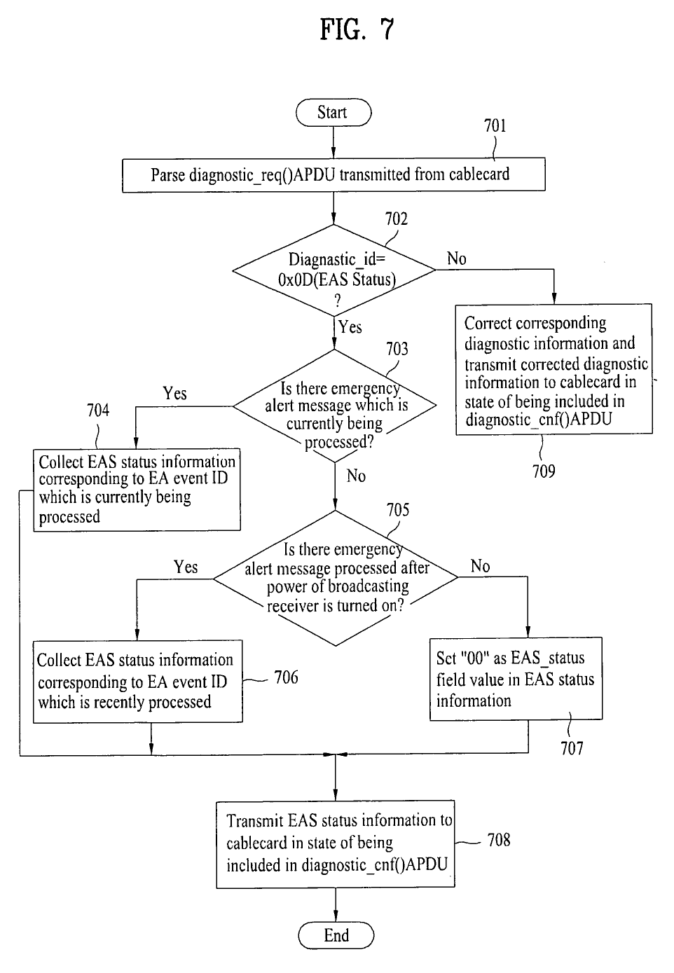

FIG. 7 shows an example of a process of, at the host, generating and transmitting the EAS status information HOST_EAS_status_report( ) to the cablecard according to the EAS status diagnostic request of the cablecard, in accordance with the present invention.

As shown in FIG. 7, the host parses the Diagnostic_req( )APDU transmitted from the cablecard (step 701), and determines whether the diagnostic ID is the EAS status request, for example, 0x0D (step 702).

If it is determined that the diagnostic ID is 0x0D in the step 702, it is indicated that the EAS status information is collected and thus it is checked whether an emergency alert message which is currently being processed by the host is present (step 703). If the emergency alert message which is currently being processed is present, the process progresses to a step 704, in which the EA event ID of the emergency alert message which is currently being processed is represented in the EAS_Event_ID field, the processing starting time of the emergency alert message is represented in the EAS_Starting_Time field, and the current time is represented in the EAS_Ending_Time field. In addition, “01” is represented in the EAS_Status field such that it is indicated that the emergency alert message corresponding to the EA event ID is currently being received and processed. For example, if it is assumed that the information included in the emergency alert message indicates the switch to an emergency alert broadcasting channel for broadcasting an emergency from 3:00 to 5:00 and the EAS status diagnostic request is transmitted from the cablecard at 4:00, the EA event ID of the emergency alert message which is currently being processed is represented in the EAS_Event_ID field in the EAS status information HOST_EAS_status_report( ) and 3:00 is represented in the EAS_Starting_Time field. In addition, 4:00 is represented in the EAS_Ending_Time field and 01 is represented in the EAS_Status field. The generated EAS status information HOST_EAS_status_report( ) is transmitted to the cablecard in a state of being included in the diagnostic confirmation Diagnostic_cnf( )APDU (step 708).

Meanwhile, if it is determined that the emergency alert message which is currently being processed is not present in the step 703, it is determined whether the emergency alert message processed after the power of the broadcasting receiver is turned on is present (step 705).

If it is determined that the emergency alert message processed after the power of the broadcasting receiver is turned on is present in the step 705, the EAS status information corresponding to the emergency alert message which is recently processed is collected (step 706). For example, it is assumed that the information included in the emergency alert message includes the switch to the emergency alert channel from 3:00 to 5:00 and this emergency alert message is the emergency alert message which is normally processed recently after the power of the broadcasting receiver is turned on. Then, the EA event ID of the emergency alert message is represented in the EAS_Event_ID field in the EAS status information HOST_EAS_status_report( ), 3:00 is represented in the EAS_Starting_Time field, and 5:00 is represented in the EAS_Ending_time field. In addition, “10” is represented in the EAS_Status field such that it is indicated that the emergency alert message is processed. The generated EAS status information HOST_EAS_status_report( ) is transmitted to the cablecard in a state of being included in the diagnostic confirmation Diagnostic_cnf( )APDU (step 708).

If it is determined that the emergency alert message processed after the power of the broadcasting receiver is turned on is not present in the step 705, the process progresses to a step 707, in which a predetermined dummy value, for example, 0 or 1, is represented as the EAS_Event_ID field, the EAS_Starting_Time field and the EAS_Ending_Time field in the EAS status information HOST_EAS_status_report( ). The value “00” indicating that the emergency alert message which is being processed or was already processed after the power of the broadcasting receiver is turned on is not present is represented in the EAS_Status field. The generated EAS status information HOST_EAS_status_report( ) is transmitted to the cablecard in a state of being included in the diagnostic confirmation Diagnostic_cnf( )APDU (step 708).

If it is determined that the diagnostic ID is not 0x0D in the step 702, the diagnostic information is collected and the collected diagnostic information is transmitted in a state of being included in the diagnostic confirmation Diagnostic_cnf( )APDU.

The cablecard transmits the diagnostic request for the EAS status to the host and the host collects and transmits the EAS status information HOST_EAS_status_report( ) to the cablecard according to the request of the cablecard as shown in FIGS. 6 and 7.

That is, the cablecard transmits the diagnostic request for the EAS status to the host according to the request of the headend or periodically. In the embodiment of the present invention, it is assumed that the cablecard requests the EAS status information to the host according to the request of the headend.

When the EAS status information HOST_EAS_status_report( ) is transmitted from the host, the cablecard transmits it to the headend.

The headend analyzes the EAS status information transmitted from the cablecard and performs an operation corresponding to the analyzed result.

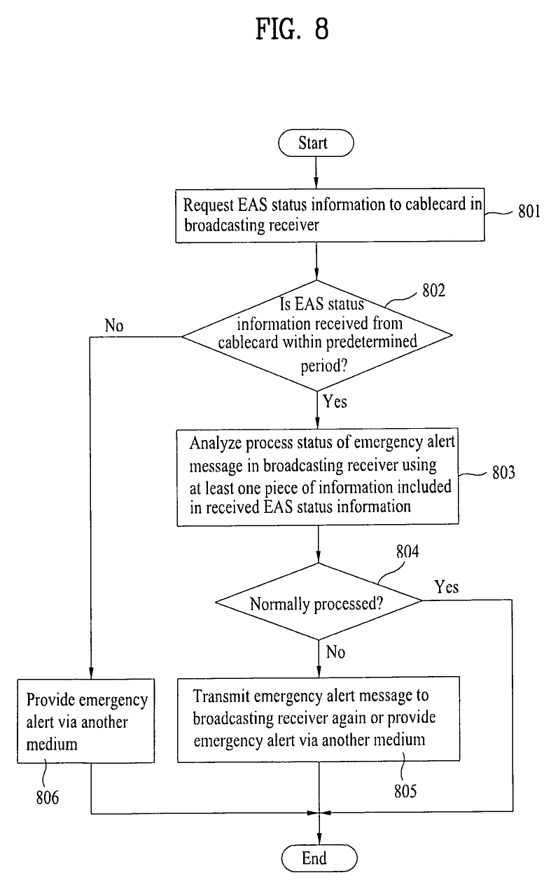

FIG. 8 is a flowchart illustrating an embodiment of a method of, at a headend, processing EAS status information according to the present invention.

First, when an emergency is generated, the headend transmits an emergency alert message including time information and indicating information to a broadcasting receiver. The emergency alert message transmitted to the broadcasting receiver further includes an EA event ID for identifying the emergency alert message, and priority information for determining the importance degree of the emergency alert message. The time information indicates information indicating the starting time and the ending time of the emergency alert message. The indicating information indicates information indicating the switch of the channel and the output of the emergency alert contents in a text or voice form. For example, if the indicating information is the switch of the channel, the indicating information may further include information on the channel to be switched.

When it is determined that the emergency alert message is being processed or was already processed by the broadcasting receiver, the headend requests the EAS status information to the cablecard in the broadcasting receiver (step 801). At this time, it is assumed that the headend stores the emergency alert message information recently transmitted to the broadcasting receiver. In the embodiment of the present invention, it is assumed that the stored emergency alert message includes the EA event ID for identifying the emergency alert message and the time information indicating the starting time and the ending time. The stored emergency alert message information may further include the indicating information which will be processed by the host of the broadcasting receiver.

At this time, the headend may request the EAS status information to the cablecard in the broadcasting receiver whenever the emergency alert message is transmitted to the broadcasting receiver or request the EAS status information to the cablecard in the broadcasting receiver only when the importance degree of the emergency alert message transmitted to the broadcasting receiver is high. The headend may determine the importance degree of the emergency alert message according to a predetermined condition or using the priority information in the emergency alert message transmitted to the broadcasting receiver.

If the EAS status information is requested to the cablecard of the broadcasting receiver in the step 801, the headend checks whether the EAS status information is transmitted from the cablecard of the broadcasting receiver within a predetermined time (step 802).

If the EAS status information is not transmitted from the cablecard of the broadcasting receiver within the predetermined time, the headend determines that the power of the broadcasting receiver is turned off and provides the emergency alert via another medium (step 806). For example, a call to a telephone registered by the subscriber of the broadcasting receiver may be tried or a text or voice message may be transmitted.

If it is checked that the EAS status information is transmitted from the cablecard of the broadcasting receiver within the predetermined time in the step 802, the processing status of the emergency alert message of the broadcasting receiver is analyzed using at least one piece of information (e.g., at least one of the EAS_Event_ID field, the EAS_Starting_Time field, the EAS_Ending_Time field and the EAS_Status field) included in the received EAST status information (step 803). If it is determined that the emergency alert message is being processed or was already processed by the broadcasting receiver for transmitting the EAS status information by the step 803 (step 804), the management of the emergency alert message of the broadcasting receiver is finished. In contrast, if it is determined that the emergency alert message is not normally processed by the broadcasting receiver for transmitting the EAS status information by the step 803 (step 804), the emergency alert message may be transmitted to the broadcasting receiver again or the emergency alert may be provided via another medium, according to the analyzed contents (step 805).

For example, if the EA event ID which is previously stored in the headend is not equal to the EA event ID in the received EAS status information, it is determined that the emergency alert message is not normally processed by the broadcasting receiver. In this case, the emergency alert may be provided via another medium or the emergency alert message may be transmitted to the broadcasting receiver again.

If the EA event ID which is previously stored in the headend is equal to the EA event ID in the received EAS status information, it is determined that the emergency alert message is normally being processed or was normally processed by the broadcasting receiver and the management is finished.

Alternatively, if the EA event ID which is previously stored is equal to the EA event ID (EAS_Event_ID) in the received EAS status information, it may be determined whether the emergency alert message is normally being processed or was normally processed by the broadcasting receiver using the starting time information EAS_Starting_Time, the ending time information EAS_Ending_Time and the EAS status information EAS_Status included in the EAS status information. For example, if the EAS_Status field value is 00, it is indicated that the emergency alert message which is being processed or was already processed after the power of the broadcasting receiver is turned on is not present. Thus, the management of the emergency alert message may be finished. If the EAS_Status field value is 01 (the emergency alert message is being processed) or 10 (the emergency alert message was already processed), it is determined that the emergency alert message is normally being processed or was already processed using at least one of the starting time information and the ending time information in the EAS status information and the management of the emergency alert message may be finished or the emergency alert may be provided via another medium according to the determined result. For example, if the EAS_Status field value is 10 and the starting time information EAS_Starting_Time and the ending time information EAS_Ending_Time included in the EAS status information are equal to the starting time information and the ending time information which are previously stored in the headend, it is determined that the emergency alert message is normally processed by the broadcasting receiver. If at least one of the starting time information EAS_Starting_Time and the ending time information EAS_Ending_Time included in the EAS status information is not equal to the starting time information and the ending time information which are previously stored in the headend, it is determined that the emergency alert message is not normally processed by the broadcasting receiver and the emergency alert may be provided via another medium. Alternatively, only when at least one of the starting time information EAS_Starting_Time and the ending time information EAS_Ending_Time included in the EAS status information is not equal to the starting time information and the ending time information which are previously stored in the headend and the importance degree of the emergency alert message is high, the emergency alert may be provided via another medium.

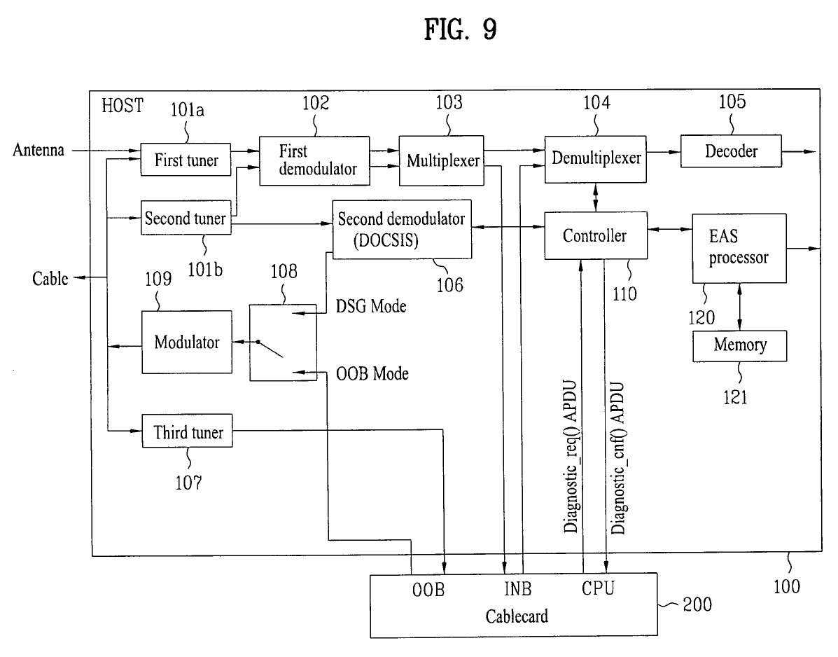

FIG. 9 is a block diagram showing an embodiment of a broadcasting receiver according to the present invention, which includes a host 100 and a cablecard 220 which is detachably connected to the host.

The host 100 may receive only a cable broadcasting signal or at least one of a cable broadcasting signal, a terrestrial broadcasting signal or a satellite broadcasting signal. In this embodiment, it is assumed that the host 100 can receive at least one of the cable broadcasting signal, the terrestrial broadcasting signal or the satellite broadcasting signal.

A bidirectional communication mode between a cable broadcasting receiver and a headend includes two methods: an out of band (OOB) mode and a DOCSIS settop gateway (DSG) mode. Accordingly, a viewer may select and view a desired program via the host using any one of the two modes. Alternatively, the viewer may directly participate in a broadcasting program and select and view necessary information. A data broadcasting service may be provided via the OOB mode and/or the DSG mode.

The OOB mode is the standard of transport specifications between a cable broadcasting station (headend) and an intersec instrument within a settop box. In contrast, the DSG mode indicates a transport mode between a cable modem control system of a cable broadcasting station and a data-over-cable service interface specifications (DOCSIS)-based cable modem within a settop box. At this time, the DOCSIS can transmit data using the cable modem.

The broadcasting receiver shown in FIG. 9 is a cable broadcast receiver using a combination of the OOB mode and the DSG mode.

The host 100 of the broadcasting receiver shown in FIG. 9 includes a first tuner 101a, a second tuner 101b, a first demodulator 102, a multiplexer 103, a demultiplexer 104, a decoder 105, a second demodulator (DOCSIS) 106, a third tuner 107, a switching unit 108, a modulator 109, a controller 110, an EAS processor 120, and a memory 121.

The cablecard 200 is one of a single (S)-card for processing a single stream and a multi (M)-card for processing a multi-stream.

The first tuner 101a tunes only a specific channel frequency of a cable audio/video (A/V) broadcasting signal transmitted in-band via a cable or a terrestrial A/V broadcasting signal transmitted via an antenna, and outputs the tuned signal to the first modulator 102.

The terrestrial broadcasting signal and the cable broadcasting signal are different from each other in a transport method. The first demodulator 102 can perform different demodulating methods with respect to different signals. For example, the terrestrial A/V broadcasting signal may be modulated by a Vestigial Sideband Modulation (VSB) method and the cable A/V broadcasting signal may be modulated by a Quadrature Amplitude Modulation (QAM) method. In this case, the first demodulator 102 demodulates the tuned signal by the VSB method or the QAM method according to a signal selected by the first tuner 101a.

The signal demodulated by the first demodulator 102 is multiplexed by the multiplexer 103 to output a stream. At this time, if a plurality of in-band tuners for receiving the cable A/V broadcasting signal is included and different channels are simultaneously tuned by the in-band tuners and are demodulated by respective demodulators to output a multi-stream, the multi-stream is multiplexed by the multiplexer 103 to output the multiplexed signal.

If the signal demodulated by the first demodulator 102 is the stream of the terrestrial broadcasting signal, the demodulated stream is output to the demultiplexer 104 via the multiplexer 103. In contrast, if the signal demodulated by the first demodulator 102 is the stream of the cable broadcasting signal, the demodulated stream is output to the demultiplexer 104 via the multiplexer 103 and the cablecard 200 mounted in a slot. The cablecard 200 includes a conditional access (CA) system for preventing illegal copy of higher value-added broadcasting contents and restricting access to the contents.

That is, if the single stream or the multi-stream of the cable broadcasting signal output from the multiplexer 103 is scrambled, the cablecard 200 descrambles the single stream or the multi-stream and outputs the descrambled stream to the demultiplexer 104. If the cablecard 200 is not mounted, the signal stream or the multi-stream of the cable broadcasting signal demodulated by the first demodulator 102 is directly output to the demultiplexer 104. In this case, since the scrambled cable signal is not descrambled, the signal is not normally displayed on the screen.

The demultiplexer 104 demultiplexes the received broadcasting stream into audio, video, and data streams, and outputs the streams to the demodulator 105. The decoder 105 may include an audio decoder, a video decoder, and a data decoder.

That is, the audio stream demultiplexed by the demultiplexer 104 is decoded by the audio decoder, the video stream is decoded by the video decoder, and the data stream is decoded by the data decoder.

The second tuner 101b tunes a specific channel frequency of the data broadcasting signal transmitted via the cable in the DSG mode and outputs the tuned signal to the second demodulator 106. The second demodulator 106 demodulates the data broadcasting signal of the DSG mode and outputs the demodulated broadcasting signal to the controller 110.

The third tuner 107 tunes a specific channel frequency of a downlink data broadcasting signal transmitted via the cable in the OOB mode and outputs the tuned signal to the cablecard 200.

If bi-directional communication between the headend and the broadcasting receiver is possible, uplink information (e.g. pay program application, diagnostic information of the host, or the like) transmitted from the broadcasting receiver to the headend may be transmitted in the OOB mode or the DSG mode. Accordingly, the embodiment of the broadcasting receiver according to the present invention may include the switching unit 108 so as to select any one of the modes and transmit the information.

In the OOB mode, user information or system diagnostic information is output to the modulator 109 via the cablecard 200 and the switching unit 108, and the modulator 109 modulates the output signal using a Quadrature Phase Shift Keying (QPSK) modulation method and transmits the modulated signal to the headend via the cable. If the broadcasting information of the user is transmitted in the DSG mode, the information is output to the modulator 109 via the controller 110 and the switching unit 108, and is modulated by the modulator 109 using a QAM-16 modulation method to be transmitted to the headend via the cable.

Meanwhile, the emergency alert message transmitted from the headend is defined in the form of an MPEG-2 table so as to be compatible with an MPEG-2 transport. This table is divided into at least one section unit and is transmitted in the form of a transport packet via in-band and OOB.

In the embodiment of the present invention, it is assumed that the cablecard is inserted into the host 100.

That is, if the cablecard 200 is inserted into the host, the emergency alert message transmitted via the OOB in the form of the table according to the SI protocol is output to the cablecard 200 via the third tuner 107. The cablecard 200 parses the received emergency alert message and outputs the parsed emergency alert message to the controller 110. The controller 110 outputs the emergency alert message transmitted from the cablecard 200 to the EAS processor 120. The EAS processor 120 switches the channel or displays the emergency alert contents in the voice or text form according to the indicating information included in the emergency alert message. The method of displaying the message includes a method of scrolling and displaying the emergency alert contents of the text form on a screen.

The EAS processor 120 stores the EAS event ID EAS_Event_ID, the emergency alert starting time information EAS_Starting_time and so on included in the received emergency alert message in the memory 121 in order to collect and send the EAS status information according to the request of the cablecard 200. When the processing of the emergency alert message is finished, the ending time EAS_Ending_time is stored in the memory 121 together. At this time, the EAS_Status field value corresponding to the EA event ID may be stored in the memory 121 or “10” may be assigned to the EAS_status field value when the EAS status information is generated according to the request of the cablecard 200. This is because the storage of the ending time in the memory 121 indicates that the processing of the emergency alert message is finished.

If another emergency alert message is received processed after the emergency alert message is processed, the EAS status information which is previously processed and stored in the memory 121 is updated to new EAS status information which is currently received and processed. If the power of the broadcasting receiver is turned off after the emergency alert message is processed, the power of the broadcasting receiver may be turned off after the EAS status information stored in the memory 121 is deleted.

The controller (CPU) of the cablecard 200 may transmit the diagnostic request Diagnostic_req( )APDU including a desired diagnostic ID to the controller 110 of the host 100. For example, when the headend requests the EAS status information to the cablecard 200 of the broadcasting receiver, the cablecard 200 transmits the diagnostic confirmation Diagnostic_cnf( )APDU, in which 0x0D is assigned to the diagnostic ID, to the controller 110 of the host 100. The diagnostic information which will be collected according to the diagnostic ID is shown in FIG. 3A.

The controller 110 of the host determines whether the diagnostic ID requested by the cablecard 200 is 0x0D, collects the diagnostic information corresponding to the diagnostic ID if the diagnostic ID is not 0x0D, and transmits the diagnostic confirmation Diagnostic_cnf( )APDU including the collected diagnostic information to the cablecard 200.

If the diagnostic ID requested by the cablecard 200 is 0x0D, the EAS processor 120 determines whether there is an emergency alert message which is currently being processed under the control of the controller 110, determines whether there is EAS status information stored in the memory 121 if there is no the emergency alert message which is currently being processed, and collects and generates the EAS status information which will be transmitted to the cablecard 200.

For example, when the EAS status information is requested from the cablecard 200 while the emergency is processed, the EA event ID included in the emergency alert message which is currently being processed is assigned to the EAS_Event_ID field and the actual processing starting time of the emergency alert message is assigned to the EAS_Starting_Time field. The current time is assigned to the EAS_Ending_Time field and “01” indicating that the emergency alert message is currently being processed is assigned as the EAS_Status field value. The generated EAS status information HOS_EAS_status_report( ) is transmitted to the cablecard 200 in a state of being included in the diagnostic confirmation Diagnostic_cnf( )APDU.

Alternatively, if there is no the emergency alert message which is currently being processed but there is the EAS status information stored in the memory 121 after the power of the broadcasting receiver is turned on, the EA event ID, the starting time and the ending time are read from the memory 121 and are assigned to the EAS_Event_ID field, the EAS_Starting_Time field and the EAS_Ending_Time field, respectively. If the EAS_Status field is stored in the memory 121, this value is read and assigned to the EAS_Status field, and, otherwise, “10” is assigned to the EAS_Status field so as to generate the EAS status information HOST_EAS_status_report( ) which will be transmitted to the cablecard 200. The generated EAS status information HOST_EAS_status_report( ) is transmitted to the cablecard 200 in a state of being included in the diagnostic confirmation Diagnostic_cnf( )APDU.

Alternatively, if there is no the emergency alert message which is currently being processed and there is no the EAS status information stored in the memory 121 after the power of the broadcasting receiver is turned on, a predetermined dummy value is assigned to the EAS_Event_ID field, the EAS_Starting_Time field and the EAS_Ending_Time field and “00” is assigned to the EAS_Status field so as to generate the EAS status information HOST_EAS_status_report( ) which will be transmitted to the cablecard 200. The generated EAS status information HOST_EAS_status_report( ) is transmitted to the cablecard 200 in a state of being included in the diagnostic confirmation Diagnostic_cnf( )APDU.

At this time, the EAS processor 120 may be included in the controller 110 or outside the controller 110 as shown in FIG. 9. The controller 110 may perform the function of the EAS processor 120. In this case, the EAS processor 120 may be omitted.

The operation of the controller 110 and the EAS processor 120 may be performed by any one of hardware, firmware, middleware and software or a combination of at least two thereof.

The generic diagnostic protocol which has been described up to now is only an example of the transport specifications for implementing the present invention and the present invention is not limited thereto. In the present invention, if the EAS status information is transmitted using the diagnostic information transport specification defined in various specifications of the cable broadcast, it is possible to obtain compatibility with cable broadcasting receivers and methods of transmitting diagnostic information, to which the specifications are applied. Accordingly, the transmission of the status diagnostic information using the generic diagnostic protocol may become a useful example.

In the present invention, the diagnostic function used for requesting and confirming the EAS status information is applicable to a digital broadcasting system for performing bi-directional communication, such as a terrestrial broadcasting system, a satellite broadcasting system, or an internet protocol television (IPTV) system, as well as a cable broadcasting system. At this time, in the satellite broadcasting system, a smart card may be used instead of the cablecard. In such a case, an interface module for interfacing with an external device may be included in the system or outside the system.

Instead of a hardware conditional access system (CAS) which is separately mounted in the broadcasting receiver, that is, a settop box or an integral type television of a subscriber, a CAS function can be performed by downloading a software CAS, which is provided by a provider, in a settop box or an integral type television of a subscriber.

A method of downloading the software CAS may be performed by automatically downloading a CA image from the headend when a security processor which is previously mounted in the settop box is connected to a network.

It will be apparent to those skilled in the art that the modification of a configuration does not change the scope of the present invention.

According to the broadcasting system and the method of processing the emergency alert message of the present invention, the status information of the emergency alert message which is currently being processed or was already processed by the broadcasting receiver is transmitted to a transmitting system using a diagnostic function, and the transmitting system analyzes the status information of the emergency alert message transmitted from the broadcasting receiver and provide the emergency alert via another medium according to the analyzed result or transmits the emergency alert message to the broadcasting receiver again. Thus, even when the power of the broadcasting receiver is turned off, it is possible to provide the emergency alert to the user and allow the user to properly cope with the emergency.

It will be apparent to those skilled in the art that various modifications and variations can be made in the present invention without departing from the spirit or scope of the invention. Thus, it is intended that the present invention covers the modifications and variations of this invention provided they come within the scope of the appended claims and their equivalents.

What is claimed is:

1. A receiving system comprising:
a host receiving and processing an emergency alert message transmitted from a transmitting system and collecting and transmitting status information of the emergency alert message which is currently being processed or was already processed; and
a card requesting the status information of the emergency alert message to the host, and receiving and transmitting the status information of the emergency alert message transmitted from the host to the transmitting system.

2. The receiving system according to claim 1, wherein the host and the card communicate with each other using a generic diagnostic protocol.

3. The receiving system according to claim 1, wherein the host configures the status information of the emergency alert message including at least one of an identifier for uniquely identifying the emergency alert message which will be transmitted to the card, processing starting time information of the emergency alert message, processing ending time information of the emergency alert message, and information indicating the processing status of the emergency alert message.

4. The receiving system according to claim 3, wherein the host stores the identifier of the emergency alert message which is recently processed, the processing starting time information of the emergency alert message and the processing ending time information of the emergency alert message.

5. The receiving system according to claim 1, wherein the card requests the status information of the emergency alert message to the host if a request for the emergency alert message is received from the transmitting system.

6. A method of processing an emergency alert message of a receiving system, the method comprising:
receiving and processing the emergency alert message transmitted from a transmitting system; and
when a request for transmission of status information of the emergency alert message is received from the transmitting system, collecting and transmitting the status information of the emergency alert message, which is currently being processed or was already processed, to the transmitting system according to the request.

7. The method according to claim 6, wherein the status information of the emergency alert message transmitted to the transmitting system includes at least one of an identifier for uniquely identifying the emergency alert message, processing starting time information of the emergency alert message, processing ending time information of the emergency alert message, and information indicating the processing status of the emergency alert message.

8. The method according to claim 6, wherein the processing of the emergency alert message includes switching to an emergency broadcasting channel or displaying emergency alert contents in a text form according to the information included in the received emergency alert message.

9. A method of processing an emergency alert message of a transmitting system, the method comprising:
generating and transmitting the emergency alert message including at least one of an identifier, a time information and an indicating information to a receiving system;
requesting status information of the emergency alert message to the receiving system; and
analyzing the status information of the emergency alert message transmitted from the receiving system and performs management of the emergency alert message of the receiving system according to the analyzed result.

10. The method according to claim 9, wherein, whenever the emergency alert message is transmitted to the receiving system, the status information of the emergency alert message is requested.

11. The method according to claim 9, wherein the status information of the emergency alert message is requested according to an importance degree of the emergency alert message transmitted to the receiving system.

12. The method according to claim 9, wherein the status information of the emergency alert message transmitted from the receiving system includes at least one of an identifier for uniquely identifying the emergency alert message, processing starting time information of the emergency alert message, processing ending time information of the emergency alert message, and information indicating the processing status of the emergency alert message.

13. The method according to claim 9, wherein the performing of the management further includes providing an emergency alert via another medium if a confirmation is not received from the receiving system during a predetermined period after the status information of the emergency alert message is requested to the receiving system.
